(19) United States
(12) Patent Application Publication
(10) Pub. No.: US 2021/0118194 A1
(43) Pub. Date: Apr. 22, 2021

(54) AUGMENTED REALITY COLOR BLINDNESS CORRECTION

(71) Applicant: Lenovo (Singapore) Pte. Ltd., Singapore (SG)

(72) Inventors: Jonathan Co Lee, Cary, NC (US); Nathan Andrew Hatfield, Raleigh, NC (US)

(21) Appl. No.: 16/658,642

(22) Filed: Oct. 21, 2019

(51) Int. Cl. G06T 11/00; G09G 5/02

(52) U.S. Cl. CPC G06T 11/001; G09G 2320/0666; G09G 2354/00; G09G 5/026

(57) ABSTRACT

One embodiment provides a method, including: identifying, using a processor, a color blindness condition associated with a user; activating, based on the color blindness condition and on at least a portion of a display of an augmented reality device, a color correction filter; and adjusting, responsive to the activating and using the color correction filter, an appearance of an object within a field of view of the portion on the display. Other aspects are described and claimed.

### BACKGROUND

Approximately five percent of the world's population is afflicted with some type of color vision deficiency (CVD), or, as it is more commonly known, color blindness. CVD generally refers to an individual's inability to distinguish between certain shades of color. More particularly, most individuals with CVD are able to see colors but have difficulty differentiating between certain shades of color pairs (e.g., between reds and greens, between blues and yellows, etc.). Very few individuals actually experience complete color blindness where they are only able to see objects in black and white or different shades of grey.

### BRIEF SUMMARY

In summary, one aspect provides a method, comprising: identifying, using a processor, a color blindness condition associated with a user; activating, based on the color blindness condition and on at least a portion of a display of an augmented reality device, a color correction filter; and adjusting, responsive to the activating and using the color correction filter, an appearance of an object within a field of view of the portion on the display.

Another aspect provides an information handling device, comprising: a display; a processor; a memory device that stores instructions executable by the processor to: identify a color blindness condition associated with a user; activate, based on the color blindness condition and on at least a portion of the display, a color correction filter; and adjust, responsive to the activating and using the color correction filter, an appearance of an object within a field of view of the portion on the display; wherein the information handling device is an augmented reality device.

A further aspect provides a product, comprising: a storage device that stores code, the code being executable by a processor and comprising: code that identifies a color blindness condition associated with a user; code that activates, based on the color blindness condition and on at least a portion of a display, a color correction filter; and code that adjusts, responsive to the activating and using the color correction filter, an appearance of an object within a field of view of the portion of the display.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of implementing color blindness correction measures using a device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Although there is no known cure for color vision deficiency (CVD), devices and tools exist that may lessen the impact of the condition. For example, contact lenses and/or glasses are available that can enhance the vibrancy and saturation of certain colors based on an individual's condition. More particularly, these “color corrective” lenses contain filters capable of causing a shift in an individual's perceived color spectrum, thereby enabling them to see certain colors they otherwise wouldn't. As another example, as CVD is primarily a congenital disease based on corrupted chromosomes, gene therapy techniques have been explored in which color vision genes have been injected into animal subjects (i.e., mice) in an attempt to revert their color blindness. However, an effective and viable treatment utilizing these techniques is still far away for human subjects.

Conventional tools for correcting CVD issues are limited in nature. More particularly, the aforementioned corrective lenses apply an absolute, global color filter to the entirety of the lens. Although such an implementation bolsters an individual's ability to visualize deficient colors, it also negatively affects perception of colors that are not impaired. In so doing, elements of the natural scene that do not require corrective enhancements are subject to a tint overlay. Additionally, these corrective lenses typically require bright outdoor lighting to function optimally, which is not always available.

Accordingly, embodiments of the underlying application utilize an augmented reality device to provide dynamic color-enhanced adjustments to local aspects of a scene to facilitate perceptual organization without also subjecting users to global adjustments. In an embodiment, a color blindness condition associated with a wearer of an augmented reality device (e.g., an augmented reality headset, another device comprising a lens or a display and having augmented or mixed reality capabilities, etc.) may be identified. An embodiment may then activate, based on the identified color blindness condition, a color correction filter on at least a portion of a display of the augmented reality device. Thereafter, responsive to activating the appropriate color correction filter, an embodiment may adjust an appearance of one or more objects in a field of view of the display. For example, an embodiment may adjust a coloring or tint of an object, may tag an object with an identification tag, etc. Such a method may therefore use augmented reality technologies as an effective tool for enhancing color perception in both indoor and outdoor environments.

The illustrated example embodiments will be best understood by reference to the figures. The following description is intended only by way of example, and simply illustrates certain example embodiments.

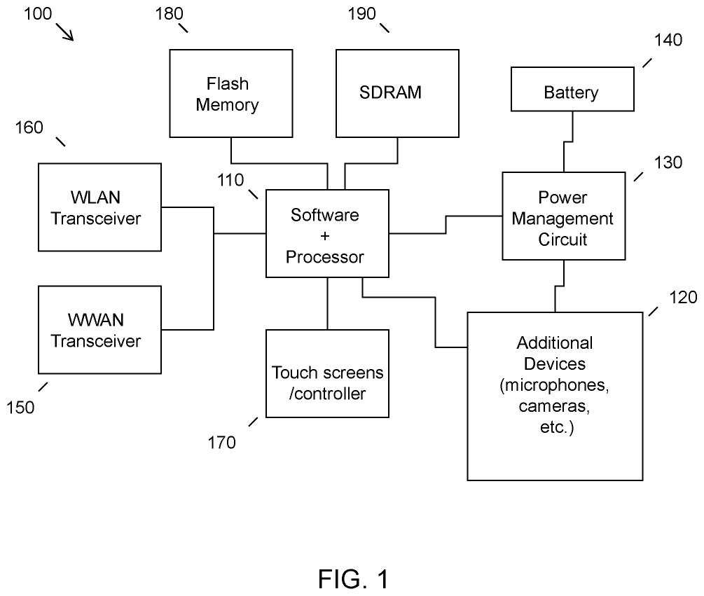

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

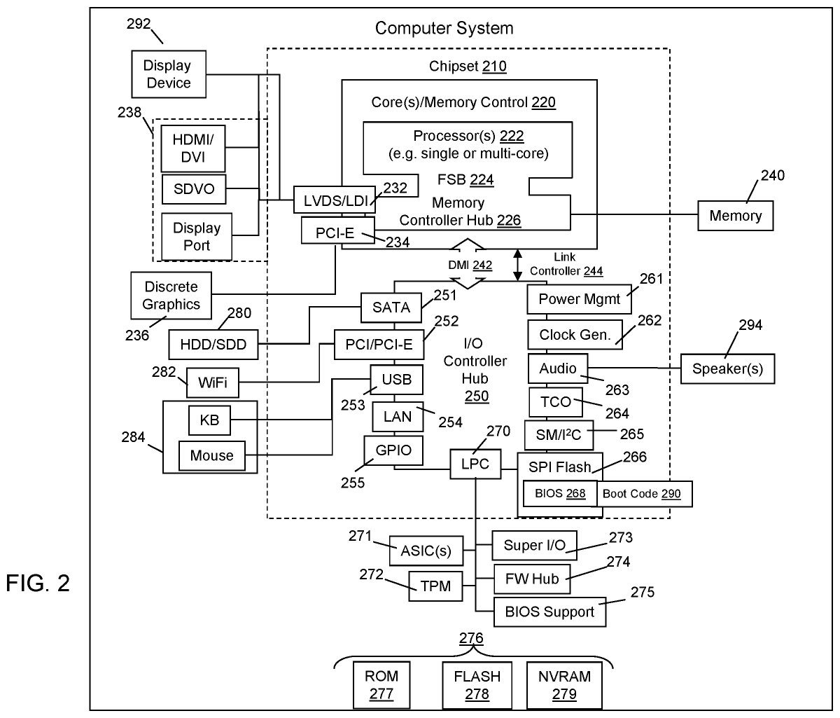

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices having augmented reality capabilities and having at least one display. For example, the circuitry outlined in FIG. 1 may be implemented in an augmented reality headset embodiment, whereas the circuitry outlined in FIG. 2 may be implemented in a smart phone.

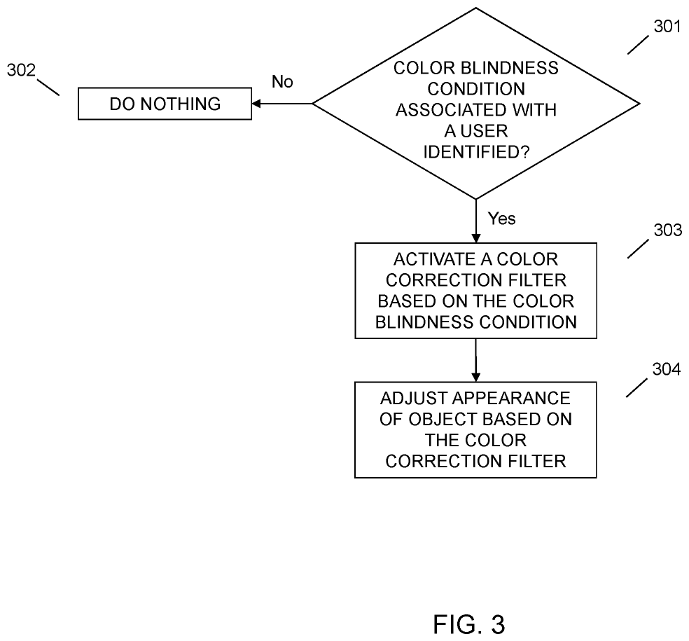

Referring now to FIG. 3, an embodiment may utilize augmented reality technology to adjust an appearance of an object based on a user's particular CVD. At 301, an embodiment may identify a CVD, or color blindness condition, associated with a user. In an embodiment, the identification may be facilitated by receiving a designation of a condition from the user. For example, an embodiment may have access to a listing of known CVD conditions (e.g., accessed from a database stored locally on the device or remotely on another device or server, etc.). A user may select (e.g., from a menu presented visually or audibly to the user, etc.) the condition that is most relevant to them. In another embodiment, a user's healthcare provider may provide an indication of the user's color blindness condition to the device. For example, an ophthalmologist could prescribe or send a software package to the user or user's device that may be related to a user's condition.

Responsive to not identifying, at 301, a user's color blindness condition, an embodiment may, at 302, take no additional action. Conversely, responsive to identifying, at 302, a user's color blindness condition, an embodiment may, at 303, activate a color correction filter (“filter”) on the user's device.

In an embodiment, the user's device may be an augmented reality device. In the context of this application, an augmented reality device may be any device that contains at least one integrated lens or display and that is capable of displaying augmented reality content on said lens or display. For example, the augmented reality device may correspond to an augmented reality headset, a smart phone, a tablet, and the like. In an embodiment, the augmented reality device may comprise additional hardware or software that enables it to dynamically detect and determine the identity and/or color of objects in a user's field of view. In another embodiment, eye-tracking technology may be supported by the augmented reality device that may enable the device to identify an object that a user is looking at on the display screen or lens. In yet another embodiment, task identification technology may be supported by the augmented reality device that may enable the device to identify a task a user is working on or a situation that a user is in (e.g., by detecting the presence of predetermined objects in a user's field of view, by detecting the performance of certain user actions, by detecting the location a user is in, by detecting additional context data, a combination thereof, etc.).

In an embodiment, the color correction filter may utilize augmented projections to address a user's particular color blindness condition. More particularly, the filter may augment the visual characteristics of certain objects in a user's field of view in order to better allow the user to visualize the objects in their true form. Unlike conventional filters that may be absolute in nature, the filter of the embodiments may only augment portions of the display that correspond to the colors known to be deficient based upon a user's condition. For example, a particular user afflicted with deuteranomaly (i.e., red-green color blindness) may have difficulty distinguishing between reds, greens, browns, and oranges. If one or more objects in a user's field of view are identified to contain red coloring, an embodiment may provide a corrective augmented overlay on only the red portions while maintaining normal visual standards on the remainder of the display. Additionally, a single device of the embodiments may be able to support multiple disparate filters, thereby negating the conventional need to acquire new glasses or contact lenses.

At 304, an embodiment may utilize the color correction filter to automatically adjust an appearance of an object in the field of view of a user on the display. Pluralities of different types of augmented adjustments are described below. It is important to note that the different adjustment types may be used alone or in combination with one another.

In an embodiment, a color of an object, or a color of a portion of an object, may be adjusted. The adjustment of the color may be implemented by augmented means via providing a tint overlay on the relevant portion. Such an overlay may operate similar to conventional color correcting lenses by blocking particular wavelengths of light that may interfere with the user's ability to perceive a specific color accurately. More particularly, most types of color blindness occur when the eye's green and red color sensitivities shift, resulting in too much of an overlap. This excessive overlap causes distinct hues to become indistinguishable. Accordingly, the tint overlay may filter out wavelengths of light at the point where this overlap occurs, thereby increasing contrast between the red and green color signals and correspondingly improving a user's ability to perceive colors accurately. Additionally or alternatively, the tint overlay may have a designated color associated with it that may serve to enhance or mute certain colors.

As previously mentioned, such an overlay may be implemented on the entirety of the display or just on a portion of it. Regarding the latter, the granular control over where the augmented tint overlay is instituted allows objects that do not contain a color that is known to be affected by the user's condition to remain unaffected. For example, if a user has difficult perceiving red and green colors but does not have difficulty perceiving blue and yellow colors then an embodiment may implement a tint overlay overtop of a red object but may not implement any tint overlay overtop of a blue object positioned proximate to the red object. Similarly, if a single object contained red and blue colors, an embodiment may implement a tint overlay over the portions of the object containing red while not implementing the overlay over the portions of the object containing blue.

Additionally or alternatively, an embodiment may provide an augmented identity tag on an object or a portion of an object. The identity tag may describe the color of the object, the identity of the object, a combination thereof, and the like. The positioning of the identity tag may be originally set by a manufacturer but may later be adjusted by a user based on their preference (e.g., the positioning of the tag may be overtop of the object, next to the object, below the object, etc.). An embodiment may provide a tag for each object in a user's field of view or, alternatively, may only provide a tag for objects a user is determined to be looking at. Regarding the latter, an embodiment may maintain visual display of the tag for a predetermined amount of time after the user has looked away from the portion of the display corresponding to the object (e.g., 3 seconds, etc.). As an example of the foregoing concepts, a user may have two apples positioned in front of them, a red apple and a green apple. An embodiment may be able to provide a color tag on each apple that identifies the color of the apples. In another example, a user may be driving a car and approaching a stoplight. An embodiment may be able to provide a designation of the color being broadcast by the stoplight when it is detected that the user looks at it. Additionally or alternatively, an embodiment may utilize the color information to provide additional instructions to a user. For instance, using the previous stoplight example, an embodiment may be able to detect when the stoplight turns red and thereafter provide (e.g., using an audio or visual notification, etc.) feedback to the user advising them to stop.

In an embodiment, additional context data may be obtained and utilized to aid a user in particular situations. More particularly, as briefly described above, systems of the embodiments may be able to identify a situation a user is in, or a task a user is attempting to complete, by identifying the presence of certain objects in a user's field of view, by identifying the color of the objects, by identifying the user's location, by receiving indications of the situation or task from user-associated context data (e.g., calendar data, communication data, social media data, etc.), a combination of the foregoing, and the like. For example, an embodiment may be able to determine that a user is an electrician that is out on a job. When presented with a variety of wires in a user's field of view, an embodiment may be able to identify the desired wire a user wishes to cut and thereafter visually distinguish that wire from the others (e.g., using augmented techniques, etc.). As another example, for a user wishing to bake a cake, an embodiment may initially identify that objects and materials within a field of view of the user are associated with a cake baking task. Thereafter, an embodiment may tag each object with its real-world identity or color and thereafter provide instructions to the user on how to complete the task (e.g., “pour the green substance into the bowl after you pour the red substance into the bowl”, etc.).

In addition to, or in lieu of, any of the foregoing adjustment techniques, embodiments of the present application may provide additional outputs that may further help a user identify colors in their field of view. For example, a user's device may be equipped with one or more speakers that may output auditory feedback. The auditory feedback may describe each identified color in the user's field of view or, alternatively, identify the color of an object a user is looking at. The activation or suspension of the auditory feedback may be adjusted by a user via interaction with their system settings. Additionally or alternatively, an embodiment may dynamically activate or suspend auditory feedback based upon a detected contextual location of a user. For example, if it is determined that a user is at work (e.g., using Global Positioning System (GPS) data, calendar data, other types of available context data, etc.), an embodiment may dynamically suspend auditory feedback. Once a user leaves work or arrives at home, an embodiment may dynamically activate audible outputs. As another example, a user may prefer auditory feedback over visual feedback in certain situations (e.g., while driving, etc.). Responsive to identifying that a user is in a situation in which they prefer auditory feedback, an embodiment may dynamically enable audible outputs.

The technical improvements described in the foregoing embodiments may further be utilized in practical, day-to-day medical situations. For instance, using the teachings of the foregoing, an optometrist could prescribe a color corrective settings adjustment as a solution to address their patient's CVD. Essentially, the settings adjustment would be equivalent to conventional medicines for the user's impairment. Such a therapy may be cheaper than existing correction techniques and may eliminate the need for a user to obtain new glasses or lenses each time a correction is required.

In addition to helping individuals with visual impairments, the concepts described in the foregoing embodiments may also be effectively utilized to help users identify colors more easily. For example, used as a learning tool, a device of the embodiments may help children differentiate between and identity individual colors quicker, especially those colors that may be more difficult to identify (e.g., shades of a color, a color that is in between two distinct colors, etc.). Additionally or alternatively, an embodiment may also help users identify an appropriate color match. For example, a user may want to match their tie to their partner's dress for an event. An embodiment may be able to first identify the color of the dress and then identify a tie color that matches the dress (e.g., by accessing an outfit matching database, etc.). Thereafter, a user may look at their tie collection through a lens of their device to allow the device to dynamically identify (e.g., via a visual or audible identification, etc.) the tie that best matches the dress.

In addition to, or in lieu of, the foregoing, the concepts described in the foregoing embodiments may also be used for certain color calibration situations. For example, a user may use their device to calibrate their television settings to match a certain color spectrum based on the colors their device identifies. More particularly, an embodiment may first receive an indication of the correct colors (e.g., from a physical or virtual source, etc.) and then view the television to spot the color differences. Thereafter, an embodiment may be able to implement any necessary adjustments to match the current television colors to the correct colors.

The various embodiments described herein thus represent a technical improvement to conventional methods for providing color corrections for individuals afflicted with CVD. Using the techniques described herein, an embodiment may first identify a color blindness condition associated with a user. An embodiment may then activate, based on the identified condition, a color correction filter on a portion of a display of an augmented reality device. The color correction filter may utilize augmented projections to adjust an appearance of an object within a field of view of the user. Such a technique may provide finer and more granular corrections to affected objects while simultaneously maintaining the accurate color appearance of unaffected objects.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
identifying, at an augmented reality device, a color blindness condition associated with a user;
identify, using context data, a profession associated with the user;
determining, using a processor and based on the profession, a task engaged in by the user:
identifying, within a captured image of a scene, an object that is relevant to completion of the task based on the profession;
identifying that the user's perception of the object will be distorted based upon the color blindness condition;
activating, on a portion of a display of an augmented reality device associated with a position of the object, a color correction filter; and
adjusting, responsive to the activating and using the color correction filter, an appearance of the object.

2. The method of claim 1, wherein the adjusting the appearance comprises adjusting a color characteristic of the object.

3. The method of claim 1, wherein the adjusting the appearance comprises adjusting a tint characteristic of the object.

4. The method of claim 1, wherein the adjusting the appearance comprises identity tagging the object.

5. The method of claim 1, further comprising:
identifying, using gaze tracking, that the user's gaze is directed at the object;
wherein the adjusting comprises adjusting the appearance responsive to identifying that the user's gaze is directed at the object.

6. The method of claim 1, further comprising identifying at least one color directly affected by the color blindness condition.

7. The method of claim 6, wherein the adjusting the appearance of the object comprises adjusting the appearance of the at least one color.

8. The method of claim 1, further comprising identifying a real-world contextual situation associated with the color; and
providing, using the augmented reality device, additional contextual information based upon the real-world situation.

9. The method of claim 1, further comprising:
identifying at least one color unaffected by the color blindness condition;
determining whether the object comprises the at least one color; and
wherein the adjusting the appearance of the object comprises not adjusting the appearance of the at least one color.

10. The method of claim 1, wherein the object comprises at least two objects and wherein the adjusting comprises adjusting the appearance of one of the at least two objects and not adjusting the appearance of another of the at least two objects.

11. An information handling device, comprising:
a camera sensor;
a display;
a processor;
a memory device that stores instructions executable by the processor to:
identify a color blindness condition associated with a user;
identify, using context data, a profession associated with the user;
determine, based on the profession, a task engaged in by the user;
identify, within a captured image of a scene, an object that is relevant to completion of the task based on the profession;
identify that the user's perception of the object will be distorted based upon the color blindness condition;
activate, on a portion of the display associated with a position of the object, a color correction filter; and
adjust, responsive to the activating and using the color correction filter, an appearance of the object;
wherein the information handling device is an augmented reality device.

12. The information handling device of claim 11, wherein the instructions executable by the processor to adjust the appearance comprise instructions executable by the processor to adjust a color characteristic of the object.

13. The information handling device of claim 11, wherein the instructions executable by the processor to adjust the appearance comprise instructions executable by the processor to adjust a tint characteristic of the object.

14. The information handling device of claim 11, wherein the instructions executable by the processor to adjust the appearance comprise instructions executable by the processor to identity tag the object.

15. The information handling device of claim 11, wherein the instructions are further executable by the processor to:
identify, using gaze tracking, that the user's gaze is directed at the object;
wherein the instructions executable by the processor to adjust comprise instructions executable by the processor to adjust the appearance responsive to identify that the user's gaze is directed at the object.

16. The information handling device of claim 11, wherein the instructions are further executable by the processor to identify at least one color directly affected by the color blindness condition.

17. The information handling device of claim 16, wherein the instructions executable by the processor to adjust the appearance of the object comprise instructions executable by the processor to adjust the appearance of the at least one color.

18. The information handling device of claim 11, wherein the instructions are further executable by the processor to identify a real-world contextual situation associated with the color; and
provide additional contextual information based upon the real-world situation.

19. The information handling device of claim 11, wherein the instructions are further executable by the processor to:
identify at least one color unaffected by the color blindness condition;
determine whether the object comprises the at least one color; and
wherein the instructions executable by the processor to adjust the appearance of the object comprise instructions executable by the processor to not adjust the appearance of the at least one color.

20. A product, comprising:
a storage device that stores code, the code being executable by a processor and comprising:
code that identifies a color blindness condition associated with a user;
code that identifies, using context data, a professional associated with the user;
code that determines, based on the profession, a task engaged in by the user;
code that identifies, within a captured image of a scene, an object that is relevant to completion of the task based on the profession;
code that identifies that the user's perception of the object will be distorted based upon the color blindness condition;
code that activates, on a portion of a display associated with a position of the object, a color correction filter; and
code that adjusts, responsive to the activating and using the color correction filter, an appearance of the object.
